(19) United States
(12) Patent Application Publication
(10) Pub. No.: US 2015/0269781 A1
(43) Pub. Date: Sep. 24, 2015

(54) Rapid Virtual Reality Enablement of Structured Data Assets

(71) Applicant: Machine Elf Software, Inc., Hyattsville, MD (US)

(72) Inventor: Christopher K. Koeber, Hyattsville, MD (US)

(21) Appl. No.: 14/662,626

(22) Filed: Mar. 19, 2015

Related U.S. Application Data
(60) Provisional application No. 61/955,269, filed on Mar. 19, 2014.

(51) Int. Cl. G06T 19/00; G06K 9/62; G06F 17/50; G02B 27/01

(52) U.S. Cl. CPC G06T 19/006; G02B 27/0172; G06K 9/6267; G06F 17/50

(57) ABSTRACT

Techniques are provided herein for enabling structured data assets for use in a virtual reality environment. These techniques may be embodied as a method, apparatus and instructions in a computer-readable storage media to perform the method. A computing apparatus having connectivity to a network receives a structured data asset that includes data portions identifying characteristics of the structured data asset. The structured data asset is converted to a uniform representation configured to be displayed in a virtual reality environment. The uniform representation of the structure data asset is continually processed and the uniform representation of the structured data asset is displayed in the virtual reality environment.

### CROSS REFERENCE TO RELATED APPLICATIONS

This application claims priority to and is based on U.S. patent application Ser. No. 61/955,269, filed Mar. 19, 2014, entitled “Virtual Reality Enabled CAD Design System and Method,” the entire disclosure of which is incorporated herein by reference.

### TECHNICAL FIELD

The present disclosure relates to enabling structured data assets for a virtual reality environment and, more specifically, to rapidly enabling structured data assets to be used or viewed in virtual reality systems, apparatuses, programs, and the like.

### BACKGROUND

Computer-aided design (“CAD”) is the use of computer systems and software to assist in the creation, modification, analysis, or optimization of a design. As some examples, CAD software is used to increase the productivity of a designer, improve the quality of a design, improve communications through documentation, and to create a database for manufacturing. CAD output is often in the form of electronic files for print, machining, or other manufacturing operations. Computer-aided design is used in many fields, including but not limited to architecture, mechanical engineering, civil engineering, manufacturing, and entertainment.

The use of computer-aided design in designing electronic systems is known as Electronic Design Automation (“EDA”). In mechanical design, CAD may be known as Mechanical Design Automation (“MDA”) and may include the process of creating a technical drawing with the use of computer software.

Virtual reality (“VR”), which is sometimes referred to as immersive multimedia, is a computer-generated environment that can simulate physical presence in places in the real world or an imagined world. Furthermore, virtual reality encompasses remote communication environments which provide a virtual presence for users with the concepts of telepresence and telexistence or a virtual artifact (“VA”) either through the use of standard input devices, such as a keyboard and mouse, or through multimodal devices, such as a wired glove or an omnidirectional treadmill. The simulated environment can be similar to the real world in order to create a lifelike experience or it can differ significantly from reality. For example, in simulations for pilot or combat training the simulated environment may be lifelike, but in games designed in a virtual reality the virtual reality may provide a fantasy environment.

Most current virtual reality environments are primarily visual experiences displayed either on a computer screen or through special stereoscopic displays, but some simulations include additional sensory information, such as sound through speakers or headphones. Some virtual reality systems also include haptic systems in order to include tactile information, generally known as force feedback in medical, gaming, and military applications. Additionally, some virtual reality systems include user-worn equipment or apparatus, such as a head mounted display. For example, the Oculus Rift, manufactured by Oculus VR, Inc. of Menlo Park, Calif., is an example of a commercially available, high field of view, low-latency, virtual reality head-mounted display designed for viewing multimedia in a visually simulated virtual reality. The device completely surrounds and covers the user's eyes such that vision is limited to what is shown on an enclosed liquid crystal display (“LCD”) built into the head mounted display. The LCD has a wide field of view, high resolution display, and ultra-low latency head tracking, and thereby provides a truly immersive experience that allows user to step inside a virtual scene and explore new worlds. Moreover, open source developments kits have been provided for the Oculus Rift, thereby providing a wide range of flexibility for software and firmware development, as well as integration.

In order to combine CAD objects with VR environments, some technology now allows CAD assets to be imported into a virtual reality environment. However, typically, a CAD asset is loaded into a VR environment without all of the intrinsic properties of the asset being recognized. For example, building designs for an office building may be opened and accessed via a CAD program, but the loaded designs are not interactive and thus can only be viewed and edited aesthetically. In other words, similar to how some word processing and portable document format (“PDF”) programs can lock or prevent certain documents (or certain portions of certain documents) from being edited, designs loaded within many CAD programs can only be manipulated in such as way where there is no intrinsic or “smart” recognition as to the functions or properties of the building being designed. Thus, in order to add recognition of physics and other intrinsic properties into an existing CAD files, a user must extensively and manually manipulate the files. For example, a user may extensively edit a CAD file within the native CAD application that created the files or by using third party tools to perform these tasks. However, each of these manual operations can take days if not weeks or months to complete.

### SUMMARY

Generally, the present invention allows for usage of virtual reality technology with structured data assets. For example, the present invention may allow virtual reality technology to be used with three dimensional assets created with or being created in three dimensional design applications, to facilitate the design workflow for design applications. The present invention may integrate natively within three dimensional design applications so that a designer would only need to only utilize native tools and a graphical user interface of the present invention to export existing design assets for viewing in virtual reality technology.

According to one embodiment of the present invention, a method of enabling a structured data asset for a virtual reality environment includes receiving a structured data asset that includes data portions identifying characteristics of the structured data asset. The structured data asset is converted to a uniform representation configured to be displayed in a virtual reality environment. The uniform representation of the structure data asset is continually processed and the uniform representation of the structured data asset is displayed in the virtual reality environment.

### BRIEF DESCRIPTION OF THE SEVERAL VIEWS OF THE DRAWINGS

Generally, like reference numerals in the various figures are utilized to designate like components.

FIG. 1 is a diagrammatic illustration of an example environment in which the present general inventive concept can be embodied.

FIG. 2 is an example flow chart depicting an example virtual reality enablement method according an embodiment of the present invention.

FIG. 3 is an example flow chart depicting operations performed by a virtual reality system to enable editing of an asset in a host design application and/or a virtual reality environment.

### DETAILED DESCRIPTION

The present inventive concept is best described through certain embodiments thereof which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments.

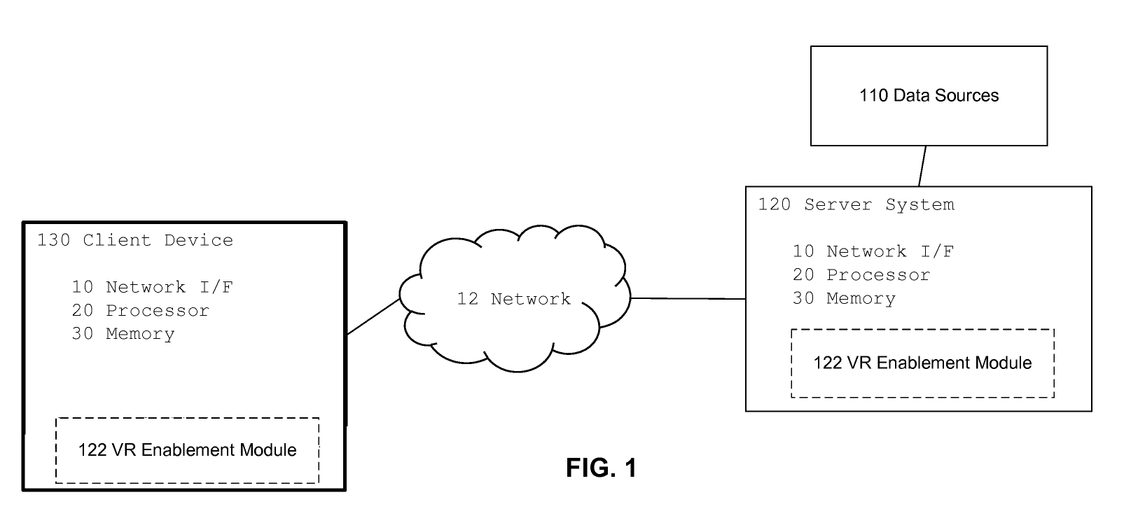

Generally referring to the FIGS. 1-3, present invention embodiments are configured to modify or convert structured data assets, such as three dimensional design data, multimedia data, and data-oriented file formats/sources into a form that is compatible with applications for viewing assets in virtual reality enabled technologies. In some embodiments the structured data assets are stored in random-access memory (RAM) in a manner which allows a user to edit the structured data asset while in RAM, and any modifications can be read from RAM. Once read, the modified structured data assets are converted into a structured digital representation that utilizes routines designed for virtual reality enabled technologies. All available data from the loaded structured data asset is viewable within the virtual environment and, depending on the loaded structured data asset, certain aspects of the data asset and/or elements in the environment are editable and/or interactive while within the virtual environment.

An example environment for use with present invention embodiments is illustrated in FIG. 1. Specifically, the environment includes one or more data sources 110, one or more server systems 120, and one or more client or end-user systems 130. Data sources 110, server systems 120, and client systems 130 may be remote from each other and communicate over a network 12. Network 12 may be implemented by any number of any suitable communications media (e.g., wide area network (WAN), local area network (LAN), Internet, intranet, etc.). Alternatively, any number of data sources 110, server systems 120, and/or client systems 130 may be local to each other, and communicate via any appropriate local communication medium (e.g., local area network (LAN), hardwire, wireless link, intranet, etc.). A data source 110 may be implemented by any conventional information storage system (e.g., database, file system server, etc.).

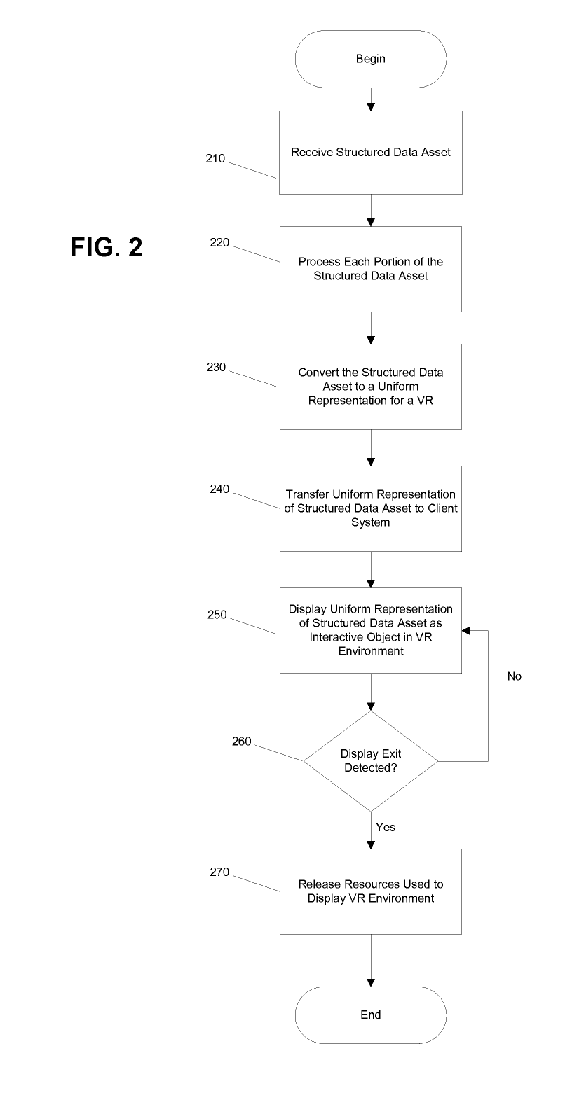

A server system 120 may include a VR enablement module 122. The VR enablement module 122 may be implemented across plural server systems. Alternatively, the VR enablement module 122, or at least a portion thereof, may reside on a client system 130 for use an interface of the client system 130. Client systems 130 enable users to communicate with the server system 120 (e.g., via network 12). The client systems 130 may present any graphical user interface (e.g., GUI, etc.) or other interface (e.g., command line prompts, menu screens, etc.) to receive commands from users and interact with the regression detection module 122 and/or other modules or services. For example, and as is described below in more detail, the client systems 130 may present an interface configured to allow a user to interact with the VR enablement module 122 or expand an interface of a client application to allow a user to interact with the VR enablement module 122. More specifically, in some embodiments, the VR enablement module 122 is embedded in a specific client application or service, such that the process illustrated and described in FIG. 2 begins when the client opens the application or starts the service.

Server systems 120 and client systems 130 may be implemented by any conventional or other computer systems preferably equipped with a display or monitor, a base (e.g., including at least one processor 20, memories 30 and/or internal or external network interface or communications devices 10 (e.g., modem, network cards, etc.)), optional input devices (e.g., a keyboard, mouse, or other input device), and any commercially available and custom software. For example, server systems 120 and client systems 130 may include a processor 20 from at least one of the following processing families: AMD K8/K10, Intel Xeon, Intel Core i7, Intel Pentium, AMD 8080, Intel Celeron, Intel Atom, Qualcomm Snapdragon, and Apple A8 and may include memory 30 that includes direct-access data storage media and/or RAM, including DDR, DDR2, and DDR3 RAM.

The VR enablement module 122 may include one or more modules or units to perform the various functions of present invention embodiments described below. The VR enablement module 122 may be implemented by any combination of any quantity of software and/or hardware modules or units, and/or may reside within memory 30 of a server system 120 and/or client systems 130 for execution by processor 20.

A manner of enabling structured data assets for a virtual reality environment (e.g. via VR enablement module 122, server system 120 and/or client system 130) according to an embodiment of the present invention is illustrated in FIG. 2. As shown, initially, a structured data asset is received at step 210. The received structured data asset may be received from disk, memory, or a network location as specified by the client. Moreover, the received structured data asset may be received in any desirable format. For example, the received structured data asset may be a three dimensional design asset with any desirable file format, a multimedia data asset of any desirable format, and/or a data-oriented asset of any desirable file format from any desirable source.

More specifically, in some embodiments, the received structured data asset is one of the following three dimensional design assets: a 3D Game Studio asset (e.g., a Modo file format), a AC3D asset (e.g., a neutral file format), an AUTODESK or AUTOCAD asset (e.g., DWG and DXF object file formats), an AUTODESK technology asset (e.g. a FBX file format), a PovRAY Raw 3D asset, an AUTODESK Revit asset (e.g., QUAKE or DOOM meshes and scenes), an AUTODESK 3ds Max (e.g., 3DS and ASE quick3D file formats), an AUTODESK 3ds Max asset (e.g. a Sense8 WorldToolkit format), a Blender asset (e.g., a 3D asset, such as the Stanford Polygon Library), a Collada asset (e.g. stereolithography), an industry foundation classes and step asset (e.g., Terragen Terrain Assets), a LightWave and Lightwave Scenesasset (e.g., TrueSpace), a Irrlicht Mesh asset (e.g., unreal scenes), an Irrlicht Scenes asset (e.g., valve scenes, an Izware Nendo asset (e.g., a wavefront object), a MICROSOFT DirectX X asset (e.g., XGL file formats), or a MILKSHAPE 3D asset (e.g., XML 3D design and data assets). Similarly, in some embodiments, the received structured data asset is one of the following multimedia assets: an APPLE HTTP Live Stream (e.g., a MPEG-2 transport stream), an animated portable network graphic asset (e.g., RAW file format), an advanced systems asset (e.g., a SBaGen script), an ADOBE FLASH video asset (e.g., a QUVI media file), an animated GIF asset (e.g., a virtual concatenation script), or an image file.

Once a structured data asset is received, each section or portion of the structured data asset is processed at step 220 in order to determine characteristics, properties, and/or functions of each portion of the structured data asset. Generally, a structured data asset is processed to determine the type of data included therein and to sort the data appropriately. However, since different assets include different data sets, different asset types may be processed slightly differently. For example, if data relating to a section of the structured data asset being processed is best represented as 3D and vector-based graphics, the processing may determine what properties to give the represented data within the virtual environment by analyzing a number of 3D related data fields included therein. Alternatively, if data relating to a section of the received structured data asset being processed is best represented as images or multimedia, then the asset will be transformed into the appropriate texture. Image processing may occur in memory via additional libraries, built-in OpenGL functions, or any other desirable manner. In still other embodiments, if the data relating to a section of the asset being processed is from a relational or sequential database or another such information source, then the data may be processed according to pre-defined configurations within the application and/or by configurations defined by the client.

More specifically, when the received structured data asset is a three dimensional design asset, the asset may include all or at least some of the following data portions: vertices; normals; indices; materials; layers/groups; and meta data, each of which is described in detail below, and each of the data portions present in the structured data asset may be read and processed. By comparison, if the structured data asset is multimedia data asset, the data included therein are essentially sequential data-streams that are viewed from one visual angle and/or read from start to finish. For example, a file representing an audio stream is read from start to finish and may represent musical instruments and/or vocals being played to the user but does not represent a physical or virtual space. Thus, the data included in a multimedia structured data asset does not directly represent a physical or virtual space and, instead, the effects shown from the asset may be processed (e.g., the amplitude of an audio asset over a specific period of time may be processed).

Still further, if the structured data asset is a data-oriented file, such as data from a relational, processing, or other such database, the structured data asset includes a variety of different forms of information which can be analyzed and presented in a desirable manner. Accordingly, the sections of data may be determined and processed in accordance with predefined rules, as described below in detail. For example, in one embodiment, a predefined rule for processing data from a sequentially structured database, such as a Microsoft structured query language (“SQL”) server database, creates a virtual representation of a wall for every data entry that is included in the results of a SQL query. Then, virtualized properties of the wall (color, dimensions, material type, etc.) could be changed to represent the data. As another example, if a data-oriented file includes statistical information about payroll data from a certain period of time, the visual representation of the data can be seen as a group of people getting older and performing different activities based on what the payroll data dictates. However, due to the wide variety of data included in data-oriented files, data oriented files can be presented in any shape or form and based on the predetermined rules.

As clarification regarding the fields that may be included in a three dimensional design asset, vertices are mathematical representations of a physical or virtual place in a defined space. Vertices can be defined by an X coordinate, Y coordinate, a Z coordinate in most cases, as well as an additional “W” coordinate which refers to whether the represented vertex posits a direction or a place in the aforementioned virtual space. Normals represent the direction that light should reflect off of any physical or virtual surface represented in the set of vertices. Thus, data relating to normals is intrinsically tied to the vertices data. Indices represent efficient ways of organizing the vertices. With index data, the total size of the data-set may be compressed significantly by not duplicating data. Materials represent the “textured” or visual representation of the structured data asset. For example, a material can be “applied” to a specific subset of the vertex, normal, and index data set, such that part of the data-set is viewed as representing physical building material. Layers and groups are elements of a data-set that represents the logical delineation of the aforementioned vertices, normal, indices, and materials that can be present in the data-set. For example, certain sections of the data-set may be represented in a file as a “group” of walls for a large building to be built or represent a single “revision” of said building. Finally, three dimensional design assets may contain data and/or information outside of the scope of the previously presented categories. This information may be presented as “meta-data” specific to the particular data-set being processed.

After a received structured asset is processed at step 220, the processed data is converted into a uniform representation of the asset that will be compatible with a VR environment at step 230. More specifically, the data processed at step 220 is sorted or categorized into predefined groups, categories, or fields in order to form. Each uniform representation will include the same predefined groups, categories, or fields and thus, once the data is sorted into these groups, each of the various assets is represented by a similar structure, regardless of how many fields are filled in the uniform representation structure.

Additionally, physics, dynamic interaction, and other intrinsic properties may be associated with specific fields and be recognized at step 220. For example, the maximum load that a certain building structure, or a portion thereof, may be calculated or recognized based on the sections referenced above (i.e., materials, vertices, normal, layers, etc.). As another example, if the structured data asset being processed is a three dimensional (3D) design file or building information management (BIM) file that represents a one hundred story building, the design file may have a significant amount of detail, including the materials used to construct the building, plumbing, electrical components, foundation, etc. When this data is processed, intrinsic properties related to these features can be incorporated into the virtualized environment so that the features interact in the same manner that they would in the real world. Thus, plumbing, electrical loads of the building, and other aspects of the asset would work as expected in the virtual environment (i.e., as these features would work in a real building).

This uniform representation is then transferred to a client system at step 240. In some embodiments, the processed data relating to each section of the processed structured data asset is converted and transferred to a client system as a uniform representation in a single process, essentially completing steps 230 and 240 in unison. Regardless, once converted and transferred, the uniform representation will be continually processed so that the uniform representation of the structured data assets may be displayed in a VR environment at step 250. The VR environment may be displayed on any suitable device or apparatus; however, if one or more head mounted displays are connected and subsequently detected, the virtual environment may be displayed via the connected head mounted displays. In some embodiments, user interactions with the VR environment may be detected via a gyroscope included on the head mounted display in order to allow a user to be immersed in the presented virtual environment. Similarly, if one or more full motion capture devices are connected and subsequently detected, a user may be able to interact with the virtual environment using data from the full motion capture devices. The resultant effects of the interaction would be more integral immersion of the user in the virtualized environment.

When a user decides to exit the display, which may be detected at step 260, the structured data assets, as well as any resources used to display the VR environment, may be released at step 270. In some embodiments, the VR display may be exited when a user selects the appropriate button or option in a presented graphical user interface. However, the resources and structured data assets will not be released until the display is exited and, thus, the VR environment will continue to be displayed for as long as a user desires. Once the assets are released at step 270, the user may then restart the process to load additional structured data assets for viewing in the same manner that the previous structured data asset was viewed.

Notably, in preferred embodiments, the entire process illustrated in FIG. 2 may be, completed instantaneously, or nearly instantaneously, such that structured data assets may be viewed in a virtual reality environment in real time or with only a minor delay. For example, when a user actuates a certain button or portion of a graphical user interface, a displayed asset may be converted into a uniform representation and displayed as an interactive object in a virtual reality environment. In preferred embodiments, the rapid (e.g., instantaneous or near instantaneous) loading of structured data assets into a VR environment may be facilitated by storing the uniform representations of the structured data assets in RAM for high speed processing and virtual presentation. More specifically, the uniform representation may be continually processed in a controlled loop as the uniform representation is displayed in a VR environment.

Moreover, in operation, a user may load multiple structured assets into a single VR environment. For example, a user may load architectural plans into a VR environment which may then be displayed with the physical attributes of the plans (i.e., materials may have realistic appearances and structural attributes) as a 3D building in the VR environment. Then, the user may also load into the same 3D environment graphics and data-oriented files, such as signs and population statistics, and the data from these assets may be incorporated into the building virtualization. For example, signs may be displayed on the sides of the building and the population statistics may fill the building with a certain population of virtualized people.

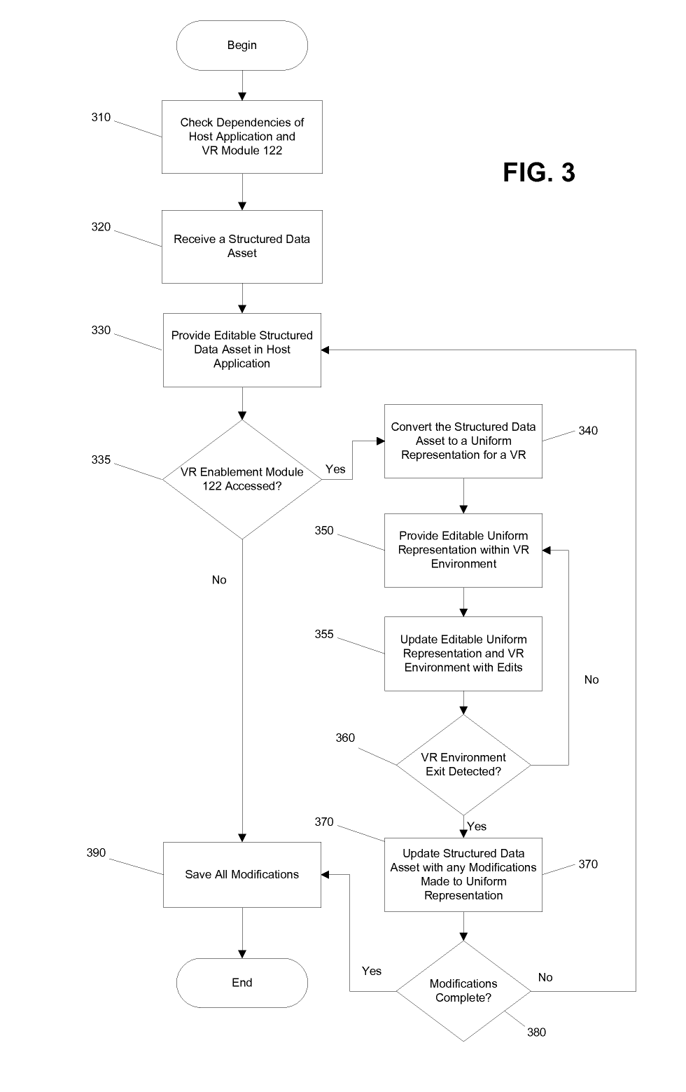

In some embodiments, the above-described process works within existing design applications, so a design application must be opened in order to initiate the process. In such embodiments, once the design application is opened the process may be activated manually or automatically, perhaps via the design application's plugin architecture. However, in other embodiments, a user may create a file while utilizing the 3D enablement module 122 and, thus, may edit a structured data asset in a host application environment and/or a VR environment. One exemplary process for editing a three dimensional design asset within a host application utilizing the VR Module 122 is illustrated in FIG. 3.

As shown in FIG. 3, first, at step 310, a host design application checks standard dependencies that are required to be met for the host design application to run, such as the amount of memory, the amount of disk space, and whether the appropriate programming libraries are installed. Then, the host design application checks if the VR enablement module is compatible with the host design application. If the application is compatible, the VR enablement module 122 may be activated, perhaps via the existing plugin architecture of the host design application, and the VR enablement module 122 performs similar checks equivalent to the host application. However, the VR enablement module 122 may have increased requirements in regard to the host system's hardware which extends beyond the host design application's performance. For example, the VR enablement module 122 may need to connect to specific hardware displays for the virtual reality-enabled environment to be fully available.

Once the dependencies of the host design application and the VR enablement module 122 are met, the host design application will load with the VR enablement module 122 capabilities, thereby extending the existing host design application's interface while allowing a user to utilize the host design application's existing features and functions as originally designed. Integrating the VR enablement module 122 in this manner allows host design application files to be edited (e.g., worked on) and/or displayed in both the display of the host design application and a virtualized environment, perhaps via a standard monitor and/or head mounted display. Additionally, when the VR enablement module is integrated in this manner, host application files may be exported from the host design application in a format that is easily presentable in a virtualized environment, either via a standard monitor or a head mounted display.

However, in some embodiments, a user may choose to skip certain checks of the VR enablement module 122 dependencies. If certain checks are skipped, related features of the VR enablement module 122 may be disabled, such as features related to displaying a desired structured data asset in a virtualized environment on standard monitors or head mounted displays. In other words, the host design application may function as originally designed without any display capabilities provided by the VR enablement module 122. In some of these embodiments, a user may edit or display a design file within the host design application and prepare the file to be exported as a uniform representation so that it may be displayed in a virtual environment on a compatible system; the user may simply be unable to view the structured data asset in a virtual environment until the exported file is viewed on the compatible system.

More specifically, when host design application files are opened using the functionality provided in the host design application, a structured data asset may be received at step 320 and provided as an editable structured data asset in the host design application at step 330. Then, the VR enablement module 122 may be activated at any time. For example, the VR enablement module 122 may be accessible via an extended interface of the host design application (e.g. the VR enablement module may be accessible via an additional menu option or button within the host design application). When, at step 335, the VR enablement module 122 is accessed, the VR enablement module 122 converts the structured data asset to uniform representation for a VR at step 340 and loads an editable version of the uniform representation in a VR environment at step 350.

In some embodiments, the editable uniform representation is displayed in a VR environment on a standard monitors or a head mounted display. However, regardless of how the editable uniform representation is displayed in a VR , the presented VR environment utilizes the host design application's editing capabilities; therefore the entire virtualized environment is fully editable at step 350. As edits are made to the environment, the VR environment will be updated to display the changes at step 355. The VR environment will continue to be displayed until a user decides to close or exit the VR environment. When, at step 360, it is detected that the VR environment is closed, the structured data asset displayed in the host design application may be updated, at step 370, to apply modifications to the structured data that correspond to the modifications made to the uniform representation in the VR environment. Thus, when the VR environment is closed, the existing host design application's interface may be presented again, but with any changes made to the structured data asset reflected, so that a user may be able to continue working on the asset in the existing host design application without having to repeat the modifications made in the VR environment again.

After all desired modifications have been made, either in the interface of the host design application or in the VR environment, all modifications may be saved at step 390. More specifically, at step 390 any modifications made to either the structured data asset or the uniform representation may be saved, however all of the modifications may be saved into both the structured data asset and the uniform representation. In other words, updated versions of the structured data asset and the uniform representation that each includes any modification made in the host design application and the VR environment may be saved at step 390. Consequently, if desired, either the structured data asset or the uniform representation may be reopened for display or additional editing at a later time. Notably, since the structured data asset and uniform representation provide data for the same object or asset, saving in this manner essentially ensures that the asset may be opened in both VR and design applications moving forward.

In other embodiments, a similar process to the process described with respect to FIG. 3 may be implemented to view a structured data asset in a VR environment without extending the editing functionality, or at least a portion thereof, of the host design application, perhaps if the editing functionality of the host design application is not compatible with the VR enablement module 122, as may be determined at step 310. For example, in some embodiments, the presented VR environment only utilizes the host design application's presentation capabilities when the VR enablement module 122 is accessed. However, since the presentation mode included in some host design applications also includes limited editing functionality (e.g., aesthetic, but not structural editing functionality), utilizing the VR enablement module 122 in this manner may allow an asset to be displayed while being modified slightly (e.g., aesthetically modified, but not structurally modified). Consequently, while in this presentation mode, a user might be able to change colors, textures, and other aesthetic related feature-sets to personalize the structured data asset and the VR environment for their uses.

It will be appreciated that the embodiments described above and illustrated in the drawings represent only a few of the many ways of implementing embodiments for enabling a structured data asset for a VR environment.

The computing environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser software, communications software, server software, etc.). These systems may include any types of monitors and input devices (e.g., keyboard, mouse, head mounted displays, voice recognition, etc.) to enter and/or view information.

It is to be understood that the software of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g.,), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The terminology used herein was chosen to best explain the principles of the embodiments, the practical application or technical improvement over technologies found in the marketplace, or to enable others of ordinary skill in the art to understand the embodiments disclosed herein; it is to be understood that alternative terminology may be preferred and, therefore, it is the substance of the description, not the semantics, that should control the understanding of the invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of new and improved methods and systems for providing rapid virtual reality enablement of structured data assets, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

What is claimed is:

1. A method comprising:
at a computing apparatus having connectivity to a network, receiving a structured data asset, wherein the structured data asset includes data portions identifying characteristics of the structured data asset;
converting the structured data asset to a uniform representation configured to be displayed in a virtual reality environment;
continually processing the uniform representation of the structured data asset; and
displaying the uniform representation of the structured data asset in the virtual reality environment.

2. The method of claim 1, wherein the structured data asset is one of a three dimensional design asset, a multimedia asset, and a data-oriented asset.

3. The method of claim 1, wherein the uniform representation of the structured data asset is editable in the virtual reality environment.

4. The method of claim 3, further comprising:
updating the structured data asset to incorporate modifications made to the editable uniform representation in the virtual reality environment.

5. The method of claim 3, wherein the uniform representation of the structured data asset is editable in a virtual environment with editing functionality of a host design application.

6. The method of claim 1, wherein converting further comprises:
processing the data portions of the structured data asset; and
categorizing each portion of the structured data asset at least based upon the characteristics identified in each portion.

7. The method of claim 1, wherein the virtual reality environment is presented via a head mounted display.

8. An apparatus comprising:
a network interface unit;
a memory; and
a processor coupled to the network interface unit and the memory, and configured to:
receive a structured data asset, wherein the structured data asset includes data portions identifying characteristics of the structured data asset;
convert the structured data asset to a uniform representation configured to be displayed in a virtual reality environment;
continually process the uniform representation of the structured data asset; and
display the uniform representation of the structured data asset in the virtual reality environment.

9. The apparatus of claim 8, wherein the structured data asset is one of a three dimensional design asset, a multimedia asset, and a data-oriented asset.

10. The apparatus of claim 8, wherein the uniform representation of the structured data asset is editable in the virtual reality environment.

11. The apparatus of claim 10, wherein the processor is further configured to:
update the structured data asset to incorporate modifications made to the editable uniform representation in the virtual reality environment.

12. The apparatus of claim 8, wherein the uniform representation of the structured data asset is editable in a virtual environment with editing functionality of a host design application.

13. The apparatus of claim 8, wherein a processor configured to convert the structured data asset to a uniform representation comprises a processor configured to:
process the data portions of the structured data asset; and
categorize each portion of the structured data asset at least based upon the characteristics identified in each portion.

14. The apparatus of claim 8, wherein the virtual reality environment is presented via a head mounted display.

15. A non-transitory computer-readable storage media encoded with software comprising computer executable instructions and when the software is executed operable to:
receive a structured data asset, wherein the structured data asset includes data portions identifying characteristics of the structured data asset;
convert the structured data asset to a uniform representation configured to be displayed in a virtual reality environment;
continually process the uniform representation of the structured data asset; and
display the uniform representation of the structured data asset in the virtual reality environment.

16. The computer-readable storage media of claim 15, wherein the uniform representation of the structured data asset is editable in the virtual reality environment.

17. The computer-readable storage media of claim 16, further comprising instructions operable to:
update the structured data asset to incorporate modifications made to the editable uniform representation in the virtual reality environment.

18. The computer-readable storage media of claim 15, wherein the uniform representation of the structured data asset is editable in a virtual environment with editing functionality of a host design application.

19. The computer-readable storage media of claim 15, wherein the instructions operable to convert the structured data asset to a uniform representation comprise instructions operable to:
process the data portions of the structured data asset; and
categorize each portion of the structured data asset at least based upon the characteristics identified in each portion.

20. The computer-readable storage media of claim 15, wherein the virtual reality environment is presented via a head mounted display.
